(19) United States
(12) Patent Application Publication
(10) Pub. No.: US 2008/0118130 A1
(43) Pub. Date: May 22, 2008

(54) METHOD AND SYSTEM FOR GROUPING IMAGES IN A TOMOSYNTHESIS IMAGING SYSTEM

(75) Inventors: Gopu Subramania Pillai, Bangalore (IN); Arun Paul, Bangalore (IN); Mani Venkatesh, Waukesha, WI (US)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/562,705

(22) Filed: Nov. 22, 2006

(51) Int. Cl. G06K 9/00

(52) U.S. Cl. 382/131

(57) ABSTRACT

A method and system for grouping images generated from a Tomosynthesis process is disclosed herein. The Method of grouping series of images obtained from a tomosynthesis process comprises generating an identifier during each imaging stage and writing the identifier to the DICOM header of the images generated during each imaging stage. The images having the same series unique identifier is displayed using a same series number. The imaging stages include pre-shot, acquisition, reconstruction and retro-reconstruction. A tomosynthesis system using the method of grouping is also disclosed.

### FIELD OF THE INVENTION

This invention generally relates to an imaging system and more particularly to, methods and systems for grouping images generated from a tomosynthesis process.

### BACKGROUND OF THE INVENTION

In classical tomography, the X-ray source and detector move synchronously and continuously in opposite directions about a fulcrum residing in a plane of interest. The tomography procedure produces an image, or tomogram, of the desired plane by blurring the contributions from other planes. In tomosynthesis, a set of two-dimensional (2-D) images is generated by pulsing the source at discrete intervals along the path used in classical tomography. The 2-D images are superimposed and translated with respect to each other to synthesize a tomogram. The plane of focus is selectable as a function of translation distance. A single exposure sequence can produce many planes for viewing by varying the shifting and adding of the 2-D images. A large number of two-dimensional images are generated during each exposure.

The 2-D images of an object are reconstructed to obtain a tomogram or three-dimensional image (3-D). For generating 3-D images, normally back projection techniques are used. A number of 3-D images are generated during reconstruction of the images. During review mode a doctor may require to retro-reconstruct the images based on some given specification that may differ from those used for reconstruction. Thus in a Tomosynthesis application, during various imaging stages such as pre-shot, acquisition, reconstruction, retro-reconstruction, etc., a large number of images are generated.

A tomosynthesis process will depend on several parameters such as kVp, mA, exposure time, collimation, field-of-view, dose, post-acquisition image processing, number of projections, dose per projection, sweep angle, total dose, angular increment between projections, reconstruction algorithm, reconstruction ‘kernel’ or filter, etc. All of these parameters can have significant effect on the nature of the reconstructed images including noise, slice thickness (z-resolution), prevalence of ripple artifacts, focal depth, field-of-view, number of slices that need to be read, etc. Thus the number of parameters that affect the three-dimensional image or tomogram is large and, based on a selected set of parameters, a large number of images may be generated during each Tomosynthesis process.

In a patient study, a doctor is able to select desired images to a visual interface for studying the images. However normally the images are grouped in a single series within a study. The images may be grouped in a series such as a patient, type of exam, examination date and time, etc. The grouping of the images based on series is achieved in many ways. Some of the solutions include automatically grouping the images based on the imaging time and exam type, date etc. However once the images are selected from different sets of images, which are obtained from different Tomosynthesis processes, and are processed, it will be difficult for the doctor to identify the process from which the individual images were generated. For example a series of images can be selected from different tomo acquisitions, and the image can be reconstructed. However, once the image is reconstructed using the selected images, it will be difficult for the doctor to identify the process or the tomo acquistions from which they were generated.

When images are displayed without appropriate grouping it will be difficult to conduct proper study and also it will be time consuming and cumbersome. For, example after retro-reconstruction, the doctor will not be able to distinguish the images based on their initial imaging stages or tomo acquisition or reconstruction process. Some times there might be a requirement that the images of particular series or acquisition may be tilted or added with annotations etc. and this will be much more difficult, if there is no proper grouping to represent the process from which the images were generated. Manual interpretation of the images clubbed together in a single series would be cumbersome and could lead to improper diagnosis. It will be difficult to do operations like adding annotations or changing orientation that are applicable only to those images that are generated during same Tomosynthesis acquisition or retro-reconstruction. This problem gets aggravated if additional Retro-Reconstructions are done on the Tomosynthesis data.

Thus it would be desirable to provide a method that facilitates the grouping of the images generated in a tomosynthesis process.

### SUMMARY OF THE INVENTION

The above-mentioned shortcomings, disadvantages and problems are addressed herein which will be understood by reading and understanding the following specification.

The present invention provides a method of grouping series of images generated from a tomosynthesis process comprising the steps of: (a) generating an identifier during a plurality of imaging stages; (b) writing the identifier to a DICOM header of a plurality of images; and (c) displaying images grouped based on the identifier. In an embodiment the plurality of imaging stages include an image-generating stage including a pre-shot and acquisition stage and an image-processing stage including a reconstruction and retro-reconstruction stage. The images include raw images and processed images. The raw images include an image acquired during pre-shot and tomo projections acquired during acquisition. The processed images include a pre-shot image and tomo slices generated during reconstruction and retro-reconstruction. In an embodiment the identifier is a DICOM (Digital Imaging and Communications in Medicine) compliant series unique identification number.

In another embodiment, a tomosynthesis system is disclosed which comprises: an imager for providing images; and a computer coupled to the imager for grouping the images during a plurality of imaging stages, wherein the grouping is based on an identifier generated during the plurality of imaging stages. In an embodiment the computer comprises a processor for generating the series unique identifier during each imaging stage and writing the identifier to a DICOM header of plurality of images during each imaging stage. In an embodiment the method of grouping is applied to Mammographic Tomosynthesis system and Radiography Tomosynthesis system.

In yet another embodiment a computer program, provided on one or more computer readable media, for grouping series of images obtained from a tomosynthesis process is provided. The computer program comprises: a routine for generating an identifier in a plurality of imaging stages; a routine for writing the identifier to a DICOM header of the images; and a routine for displaying images grouped based on the identifier. The routine for generating an identifier comprises a routine for generating a DICOM compliant series unique identifier, during each imaging stage and updating the DICOM header of plurality of images during plurality of imaging stages with corresponding identifier.

Various other features, objects, and advantages of the invention will be made apparent to those skilled in the art from the accompanying drawings and detailed description thereof.

### BRIEF DESCRIPTION OF THE DRAWINGS

FIG. 1 illustrates a schematic diagram of an imaging system capable of grouping a series of images as described in an embodiment of the invention;

FIG. 2 is a high level flowchart depicting a method of grouping series of images obtained from a tomosynthesis process as described in an embodiment of the invention;

FIGS. 3A and 3B is a flowchart describing, in greater detail, exemplary steps of a method of grouping series of images in accordance with aspects of the invention illustrated in FIG. 2;

FIG. 4 is a flowchart describing, in greater detail, exemplary steps of a method of grouping a series of images in accordance with aspects of the invention illustrated in FIG. 2;

FIG. 5 is a visual representation grouping of series of images, as represented in an embodiment of the invention;

FIGS. 6A, 6B and 6C illustrate visual representations of grouped images as described in an embodiment of the invention;

FIG. 7 is a visual representation of a user interface displaying the method of grouping as disclosed in an embodiment of the invention; and

FIG. 8 is a visual representation of grouped images using the method of grouping as described in an embodiment of the invention.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the invention. The following detailed description is, therefore, not to be taken as limiting the scope of the invention.

In various embodiments, a method of grouping series of images obtained from a tomosynthesis process is disclosed. The images generated in different Tomo acquisitions for the same anatomy are being grouped in different series. The technique is applicable to any imaging device, wherein a large number of images are generated in a single shot. While the invention is explained with reference to a tomosynthesis system, it should be possible to apply the grouping method to various other X-ray imaging devices such as a computed tomography device, a positron emission tomography device, a magnetic resonance imaging device, an ultrasound imaging device and an X-ray device.

While the present technique is described herein with reference to medical imaging applications, it should be noted that the invention is not limited to this or any particular application or environment. Rather, the technique may be employed in a range of applications, such as baggage and parcel handling and inspection, part inspection and quality control, and so forth, to mention but a few.

The present invention also provides a tomosynthesis system utilizing a method of grouping of images as described in an embodiment of the invention. In an embodiment the method of grouping the images is applied to Mammographic Tomosynthesis system and Radiography Tomosynthesis system.

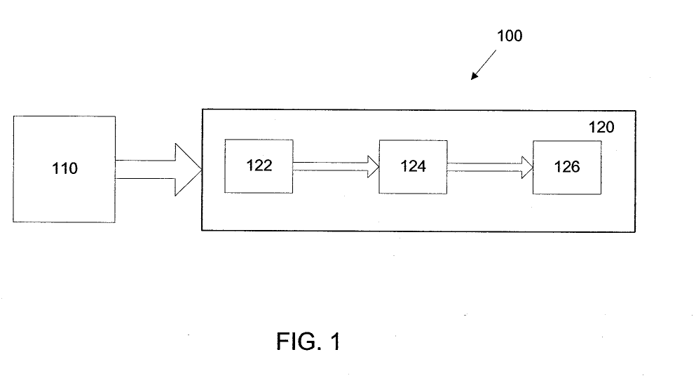

FIG. 1 illustrates a schematic diagram of an imaging system capable of grouping series of images as described in an embodiment of the invention. The imaging system 100 is used for acquiring and processing projection image data and reconstructing a volumetric image or 3D image representative of the imaged object. In the embodiment illustrated in FIG. 1, the imaging system 100 is a Tomosynthesis imaging system. However it should be noted that the imaging system may be an X-ray imaging system wherein the imaging system generates a large number of images in a single shot. The imaging system includes an imager 110 and a computer 120. The imager 110 comprises a freely movable X-ray radiation source (not shown), which is capable of emitting X-ray radiations in different directions. A stream of radiation is emitted by the source and impinges an object, for example, a patient in medical applications. A portion of the radiation passes through or around the object and impacts a detector (not shown). The detector includes an array of detector elements, which produce electrical signals that represent the intensity of the incident X-ray beam. These signals are acquired and processed to reconstruct a volumetric image or 3D image of the features within the object. The detector may be stationary, or may move synchronously and continuously with the source in opposite directions depending on the embodiment.

The source can be controlled for controlling the various tomosynthesis parameters such as the number of projections, dose per projection, sweep angle, total dose, angular increment between projections, etc. By varying any of these parameters, different sets of images can be created. The various parameters affecting the 3-D image may include slice thickness, ripple artifact level, image noise level, motion artifacts and field of view, and the anatomic characteristics such as body part thickness, high contrast structures, both natural and implanted, that create ripple artifacts, anatomic density and scan orientation. So depending on the anatomy, image characteristic, etc., different parameters may be set in an acquisition process. Based on the selected acquisition parameters a series of 2-D images or tomo projections are acquired.

The tomo projections are reconstructed to form a series of Tomo slices or 3-D image. The reconstruction may also depend on the back projection algorithm, reconstruction filter, slice pitch, edge enhancement, noise reduction, number of reconstructed images, and averaging or combining of reconstructed images. Thus during reconstruction stage also a series of images are created based on the selected parameters.

The computer 120 comprises a user interface 122, a processor 124 and a display 126. The user interface 122 may be a keyboard, mouse, joystick or any other input device, that will allow a user or doctor to interact with the computer. The user interface 122 is also configured to be a visual interface wherein, the user can select a plurality of images from different groups of images to be viewed on the display 126. In an example the images to be viewed may be selected from a memory located in the computer 120 using the user interface 122. Alternately the computer 120 may get the images directly from the imager 110 or from an intermediate device such as a memory device, which can store the images and can feed the images to the computer on need basis.

As used herein, the term ‘computer’ may include any processor-based or microprocessor-based system that includes systems using microcontrollers, reduced instruction set circuits (RISC), application-specific integrated circuits (ASICs), logic circuits, and any other circuit or processor capable of executing the functions described herein. The above examples are exemplary only, and are not intended to limit in any way the definition and/or meaning of the term ‘computer’.

In an embodiment the processor 124 is configured to receive commands and scanning or acquisition parameters from an operator and synchronize the operation of the imager and computer. The processor obtains raw images from the imager and processes the same to reconstruct 3-D images.

In an embodiment the processor 124 is configured to generate an identifier during each plurality of imaging stages. In an embodiment the identifier is a DICOM compliant series unique identifier, comprising company identification, modality identification and a random number. However it should be noted that these parameters may not be limited to the above mentioned and, based on the application and need, the series unique identifier may be generated based on different criteria/ parameters. The imaging stages include an image-generating stage such as pre-shot and acquisition, and an image processing stage such as reconstruction and retro-reconstruction. The series unique identifier is generated corresponding to each set of images generated or created during each imaging stage. The images include raw images as well as processed images. The raw images include an image acquired at pre-shot and the tomo projections acquired during a tomo acquisition. The processed images include a pre-shot image obtained from the pre-shot, which is performed at the beginning of an acquisition, to check the quality of the image and tomo slices created during reconstruction or retro-reconstruction.

In an embodiment the processor 124 generates a series number corresponding to each series unique identifier. This series number is used for displaying the images having the same series unique identifier. Normally the series unique identifier comprises information about the company, modality, etc., hence it is not preferable to display the grouped images with a series unique identifier. Hence a series number is generated corresponding to the series unique identifier for displaying images corresponding to each series unique identifier.

The processor 124 further includes a memory (not shown), for storing the images acquired or generated during the Tomo acquisition. The images generated are stored in the memory. The processor 124 is further configured to write the series unique identifier to DICOM header of the images. Thus during each imaging stage a series unique identifier is generated and is written to the DICOM header of the images generated during corresponding imaging stage. The DICOM header will be accessable to the user or doctor for interpreting the imaging stage at which the image is generated.

In an embodiment the DICOM header of the images is stored with a series number, data and time of acquisition, etc.

In an embodiment the processor 124 may sort the images generated in a tomo synthesis process based on the series unique identifier and the sorted images may be stored in the memory. Thus it will be easy for some one to view the images generated during a particular imaging stage of a Tomo synthesis process.

The computer is further provided with a display 126. The display 126 is provided for observing the reconstructed volumetric image, or a suitably processed version thereof, and to control imaging. The images grouped based on the series unique identifier are displayed in a group indicated with the same series number. The display may also be configured to be a visual interface for selecting the images from different tomo acquisition for a patient study. The visual interface will display a series of images selected by the user or doctor.

In an embodiment the radiologist or user is allowed to cine playback, copy or delete a set of images, which are associated with same process or having same series unique identifier, generated in the same Tomosynthesis acquisition or reconstruction.

In an embodiment the invention provides a computer program, provided on one or more computer readable media for grouping series of images obtained from a tomosynthesis process. The computer program comprises: a routine for generating an identifier in a plurality of imaging stages; a routine for writing the identifier to a DICOM header of the images; and a routine for displaying images grouped based on the identifier. The routine for generating an identifier comprises a routine for generating a DICOM compliant series unique identifier during each imaging stage and updating the DICOM header of plurality of images during plurality of imaging stages with corresponding identifier. The routine for writing the series identifier further comprises, displaying the images after each imaging stage. The routine for displaying the grouped images comprising generating a series number for displaying the images grouped after each imaging stage, based on the series unique identifier. The grouped images are displayed with corresponding series number. The images having same series number will have same series unique identifiers and will be generated from the same imaging stage in a Tomo synthesis process.

The routine may include various commands that instruct the processor to perform specific operations, such as the method steps of the various embodiments of the invention. The routine may be in the form of a software program. The software may be in various forms, such as system software or application software. Further, the software may be in the form of a collection of separate programs, a program module within a larger program, or a portion of a program module. The software may also include modular programming in the form of object-oriented programming. The processing of input data by the processing machine may be in response to user commands, to results of previous processing, or in response to a request made by another processing machine.

As used herein, the terms ‘software’ and ‘firmware’ are interchangeable and include any computer program stored in memory, to be executed by a computer, including RAM memory, ROM memory, EPROM memory, EEPROM memory, and non-volatile RAM (NVRAM) memory. The above memory types are exemplary only and do not limit the types of memory used for storing a computer program.

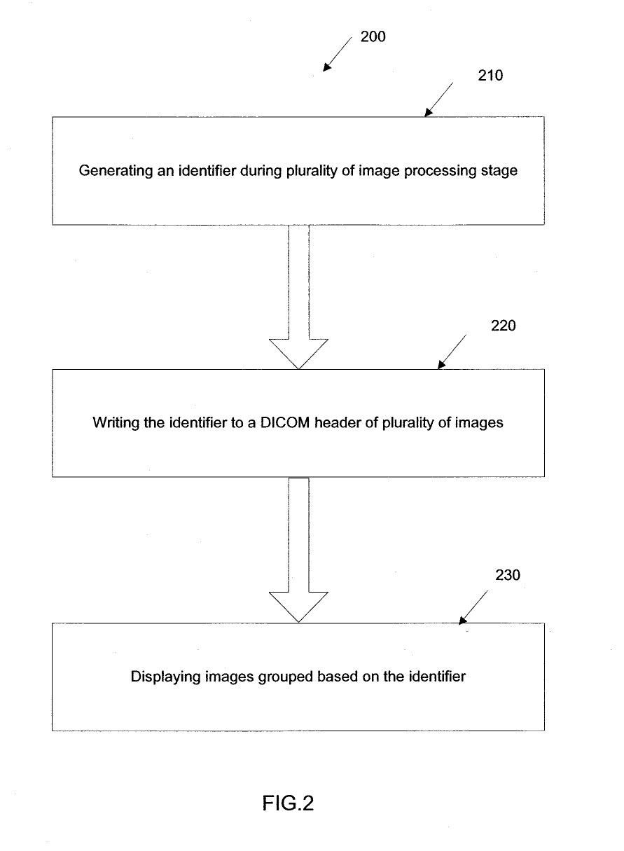

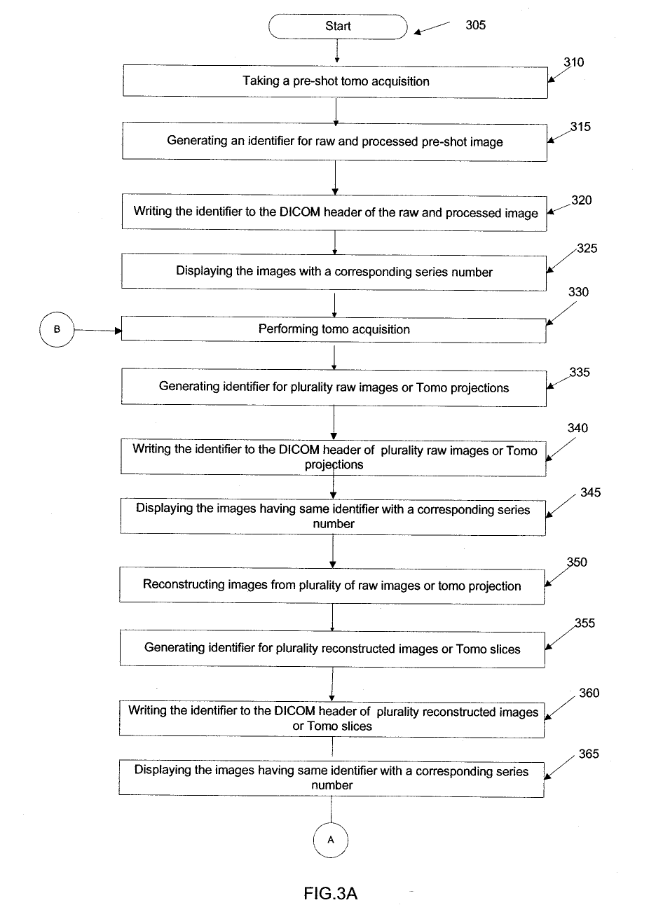

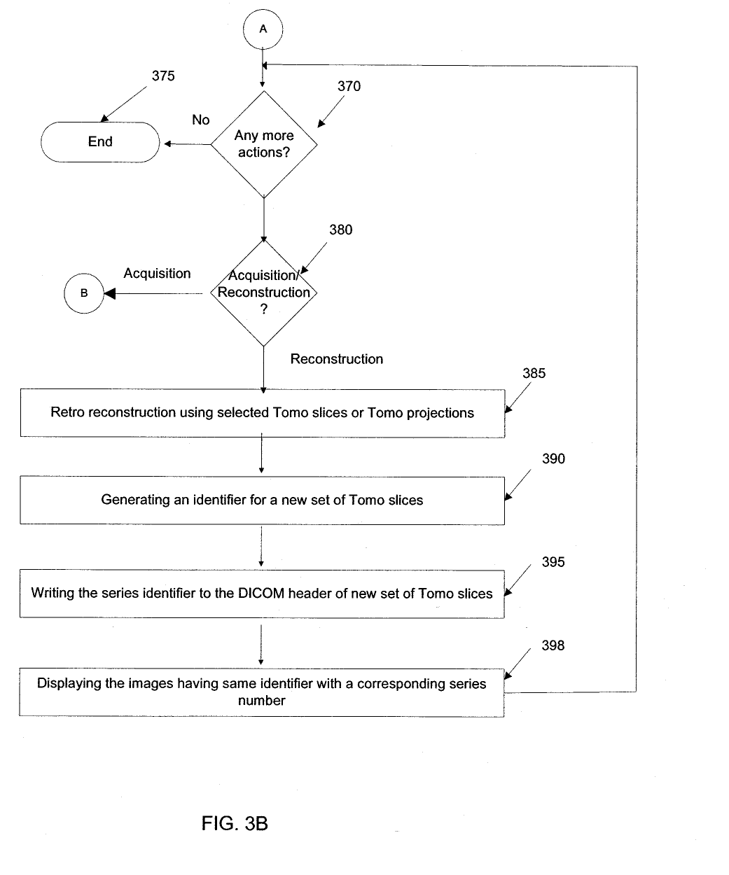

FIG. 2 is a high level flowchart depicting a method of grouping series of images obtained from a tomosynthesis process as described in an embodiment of the present invention. At step 210, an identifier, is generated during each imaging stage. The imaging stages include pre-shot, acquisition stage, reconstruction stage and retro-reconstruction stage. The series unique identifier is generated for both raw as well as processed images. The raw image includes the unprocessed images in pre-shot and tomo projections acquired during acquisition. The processed images include pre-shot image generated during pre-shot and tomo slices generated during reconstruction or retro-reconstruction. The identifier is a series unique identifier, which is a DICOM compliant number comprising of company information, modality information and a random number. At step 220, the identifier generated during each imaging stage is written to the DIOCM header of the corresponding images. For example during acquisition process, a set of Tomo projections is acquired. All the Tomo projections acquired in the acquisition process will have a series unique identifier and this series unique identifier will be written to DICOM header of all the Tomo projections acquired during that acquisition. Similarly during each imaging stage a series unique identifier is generated and is written to the DICOM header of the images acquired or generated during the corresponding tomo synthesis imaging stage. At step 230, the images having same series unique identifier is displayed in a group. A series number is generated corresponding to each series unique identifier and the series number is displayed in the grouped images. The various steps involved in method of grouping are explained in detail in FIGS. 3A, 3B & 4.

FIGS. 3A and 3B are a flowchart describing, in greater detail, exemplary steps of method of grouping series of images in accordance with aspects of the present technique illustrated in FIG. 2. A step 305, the Tomosynthesis process for generating a 3-D or volumetric image of an object is started. At step 310, a pre-shot Tomoacquisition is taken. During a tomosynthesis process depending on the anatomy and the required view, the user or operator may select a desired tomo protocol. Using the selected Tomo protocol the user takes a pre-shot. The pre-shot is performed for checking the quality of the 3-D image. The pre-shot acquires a raw image and the raw image is processed to generate a Pre-shot image. At step 315, a series unique identifier is generated for the raw image acquired during pre-shot as well as the processed or pre-shot image. At step 320, the corresponding series unique identifier is written to the DICOM header of the raw image and pre-shot image. At step 325, the raw and processed images are displayed. A series number is generated corresponding to the series unique identifier. The image is displayed along with the series number. The user may check the quality of the pre-shot image and if satisfied, may proceed with the tomo acquisition. At step 330, the user configures the tomosystem with the selected tomo protocol and using the selected tomo protocol the user performs Tomo acquisition. A large number of raw images are acquired and processed images are generated during acquisition. The raw images acquired during acquisition are known as Tomo projections and the processed or reconstructed images are referred to as tomo slices. At step 335, during acquisition stage (i.e during acquisition of tomo projections), a series unique identifier is generated corresponding to the acquisition stage. The plurality of 2-D images or tomo projections acquired during the acquisition stage will have the same series unique identifier. At step 340, the series unique identifier generated is written to the DICOM header of the plurality of tomo projections acquired during the acquisition. At step 345, a series number is generated corresponding to the series identifier and the tomo projections having same unique series identifier is displayed with same series number. At step 350, the tomosynthesis process applying suitable reconstruction algorithm, generates reconstructed 3-D images or tomo slices. The images generated during reconstruction or tomo slices are also large in number. At step 355, a series unique identifier is generated during reconstruction stage (i.e during generation of tomo slices) and at step 360, the series unique identifier is written to the DICOM header of plurality of Tomo slices. At step 365, a series number is generated corresponding to the series unique identifier and the tomo slices having same series unique identifier is displayed with same series number. A series unique identifier is generated during each acquisition stage and reconstruction stage. The corresponding series unique identifiers are written to the DICOM header of the tomo projections as well as the tomo slices. Corresponding to each series unique identifier, a series number is generated. The images having same series unique identifier is displayed with the corresponding series number. At step 370, the tomosynthesis system will check for any further actions. If no further action, it will end the process, shown at step 375. If the Tomosynthesis process has further actions it will check whether the future action is relating to acquisition or reconstruction and is represented by step 380. If the action is acquisition, the process will perform steps 330 to 370. As explained earlier a series unique identifier is generated for each acquisition stage and reconstruction stage. The corresponding series unique identifiers are written to the DICOM header of the tomo projections as well as the tomo slices. Corresponding to each series unique identifier a series number is generated and the images having same series unique identifier is displayed with same series number. If the action is reconstruction, at step 385, the images are retro-reconstructed using the selected Tomo slices or projections. At step 390, as explained earlier, a series unique identifier is generated and at step 395, the series unique identifier is written to the DICOM header of the new set of Tomo slices or retro-reconstructed images. At step 398, corresponding series number is generated and the images are displayed with the series number.

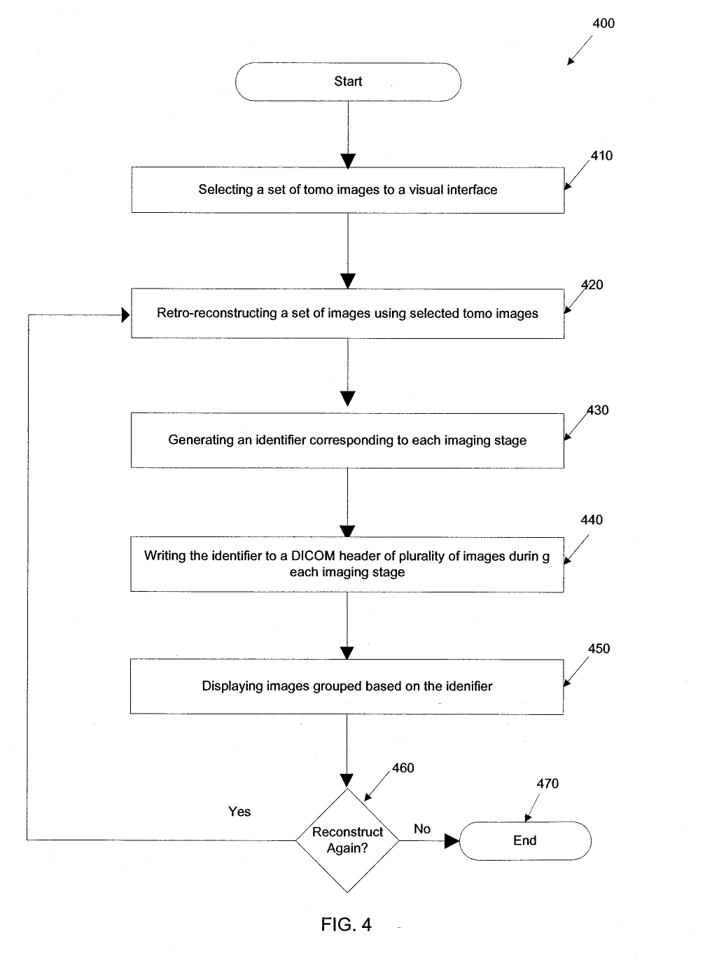

FIG. 4 is a flowchart describing, in greater detail, exemplary steps of method of grouping series of images in accordance with aspects of the present technique illustrated in FIG. 2. The flowchart 400 illustrates the steps of method of grouping in a review mode. In review mode, the doctor or the operator may select different slices or tomo projections from a Tomo acquisition or tomo synthesis process and may reconstruct image using the selected tomo projections or tomo slices. At step 410, the user selects the required tomo images to a visual interface. The tomo images may include Tomo slices and Tomo projections. At step 420, the images are reconstructed using selected reconstruction parameters. At step 430, an identifier is generated corresponding to the retro-reconstruction stage. The identifier is a series unique identifier, which is a DICOM compliant number, comprising company identification, modality identification and a random number. At step 440, the generated series unique identifier is written to the DICOM header of the plurality of the images generated during retro-reconstruction. At step 450, the images having same series unique identifier is grouped and displayed as a single group. A series number is generated corresponding to each series unique identifier and the series number is displayed in the grouped images. At step 460, the Tomosynthesis system checks for further action and in the absence of any further action the tomo synthesis system closes the process at step 470. In the event of a further action, the tomo synthesis system will perform the steps 420 to 460. During each retro-reconstruction stage, a series unique identifier is generated and written to the DICOM header of the images generated during the retro-reconstruction.

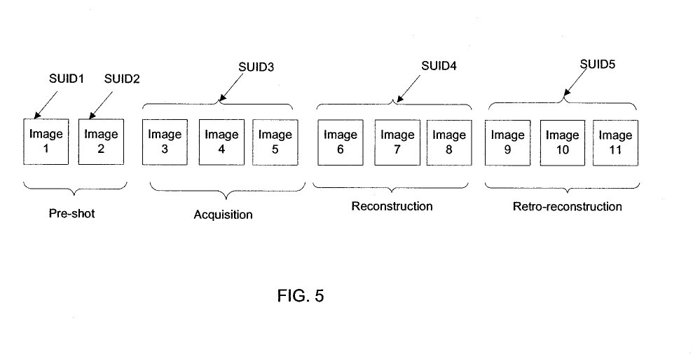

FIG. 5 is a visual representation grouping of images, as described in an embodiment of the invention. The first stage in the tomosynthesis process is a pre-shot. The pre-shot is performed for deciding the quality of the image. This is an optional step in the Tomosynthesis process. The pre-shot results in two images Image1 and Image 2. Imagel is an unprocessed image or the image acquired during pre-shot and the Image 2 is the processed image obtained from the pre-shot. During the acquisition of Image 1 and generation of Image 2 different series unique identifiers are generated. The series unique identifiers are represented as SUID1 for Image1 and SUID 2 for Image 2. The series unique identifier SUID1 and SUID2 will be stored in the DICOM header of the Image1 and Image 2 respectively. The tomosynthesis system may display the raw and processed pre-shot images, the DICOM header of the images will have the series unique identifier representing the process of acquisition. By using a user interface a user can interpret the DICOM header of the image.

In the tomo acquisition stage, the tomosynthesis system acquires a large number of 2-D images or tomo projections. The figure represents only three tomo projections Image 3, Image 4 and Image 5, but there will typically be a large number of images ranging from 50 to 100 or more. For all the tomo projections acquired in a single acquisition, represented as Image 3, Image 4, and Image 5,a single series unique identifier SUID 3 is generated and is stored in the DICOM header of all the tomo projections acquired. During the reconstruction stage the tomo projections or two-dimensional images are back projected to reconstruct three-dimensional image or tomo slices.

In a reconstruction stage, the reconstruction process can be controlled by the user by selecting desired reconstruction parameters. The reconstruction stage will also generate a series of images typically ranging from 50 to 100 or more. The figure shows only three images represented as Image 6, Image 7 and Image 8. A series unique identifier SUID4 is generated and written to the DICOM header of the reconstructed images represented as Image 6, Image 7 and Image 8.

In some cases the doctor may require to retro-reconstruct the reconstructed images using a different specification. During this retro-reconstruction process as well a series of images are generated, represented as Image9, Image 10 and Image11. During the retro-reconstruction stage, a series unique identifier is generated, represented as SUID 5 and is written to the DICOM header of the Image 9, Image 10 and Image 11. Similarly a number of acquisitions, reconstruction and retro-reconstructions are performed in a Tomo process and during each process a series unique identifier is generated and is written to the images generated or acquired during that process. Thus it will be easy to check the process from which the images are generated by interpreting the DICOM header of the images using a user interface.

However while displaying the images in a visual interface, the images will not display the DICOM headers of the images. To identify the images grouped, a series number is generated corresponding to each series unique identifier and the series number is displayed along with the grouped images. The images in a group will have same series number. Hence without interpreting the DICOM header the user or the doctor is able to identify the images grouped in a series.

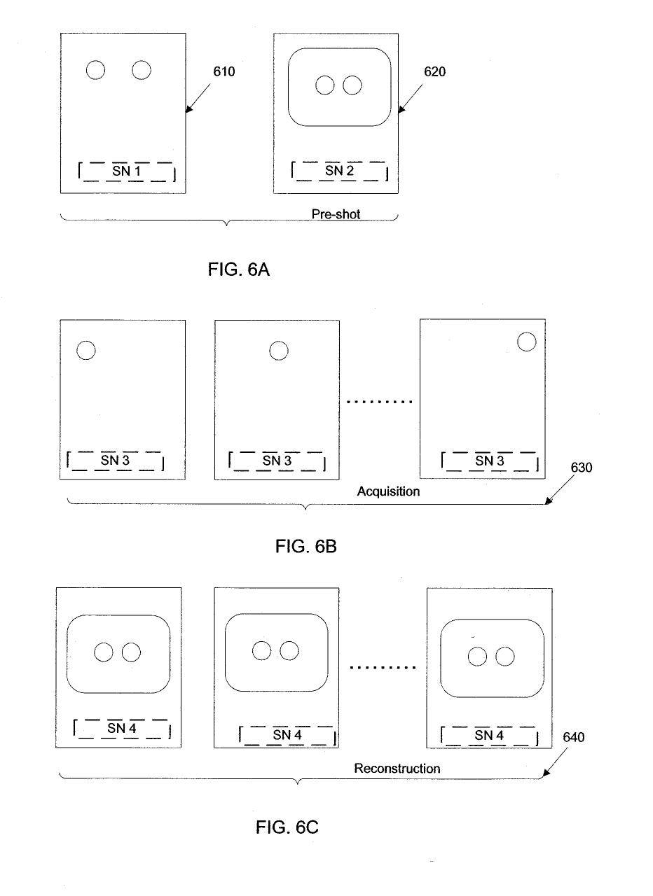

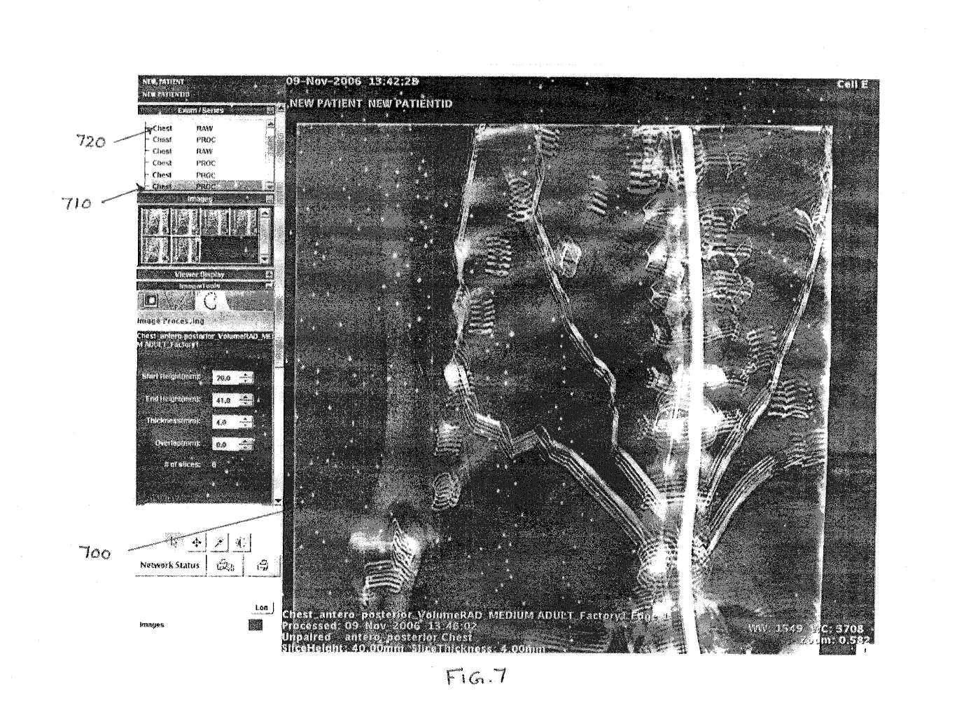

FIGS. 6A, 6B and 6C illustrate a visual representation of grouped images using the method of grouping as disclosed in an embodiment of the invention. FIG. 6A represents the images generated during pre-shot. As explained in FIG. 5, the pre-shot will acquire unprocessed image 610 and generate a processed image 620. Corresponding to images 610 and 620 series unique identifiers SUID1, SUID2 are generated and are stored in the DICOM header of the respective images. Corresponding to SUID1 and SUID2 a series number SN1 and SN2 are generated. The images 610 and 620 are displayed with corresponding series numbers SN1 and SN2. FIG. 6B represents the images acquired during acquisition or the tomo projections. The tomo projections are represented as 630 and the series unique identifier generated corresponding to the tomo projections are represented as SUID 3. Corresponding to SUID3 a series number SN3 is generated. The images 630 are displayed with corresponding series number SN3. Similarly FIG. 6C represents the images generated during reconstruction and are represented as 640. The series unique identifier generated corresponding to the reconstructed images 640 is represented as SUID 4 and is written to the DICOM header of the reconstructed images 640. Corresponding to SUID4, a series number SN4 is generated. The images 640 are displayed with corresponding series number SN4.

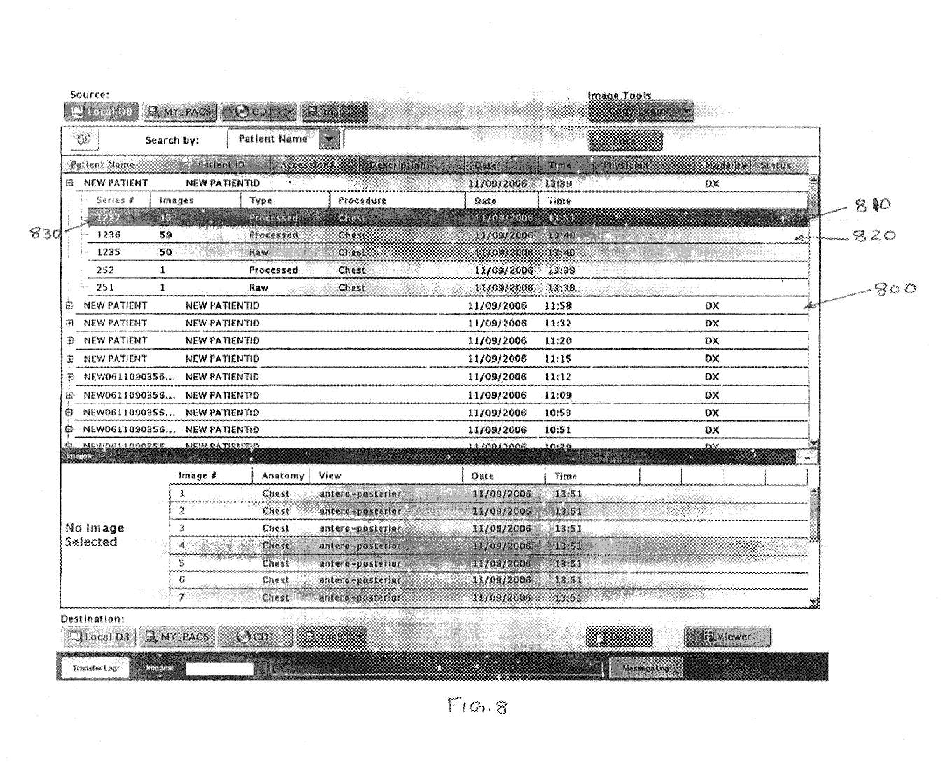

FIG. 7 is a visual representation of a user interface displaying the method of grouping as disclosed in an embodiment of the invention. The figure shows a visual interface 700 showing an image generated in an intermediate step during a tomo synthesis process. A Toolbox 710 is displayed indicating different features of the images being generated. During the tomo synthesis process a series of images are generated. As described earlier during each imaging stage a series unique identifier is generated. In an embodiment, corresponding to each imaging stage, a new row 720 is created in the tool box. The row is created corresponding to raw as well as processed images generated during each imaging stage. Each row will have unique series unique identifiers. By clicking on each row a radiologist can view the images grouped based on the process of generation.

FIG. 8 is a visual representation of grouped images using method of grouping as described in an embodiment of the invention. The figure shows visual interface 800, showing different series of images grouped using series unique identifiers. The visual interface includes a tool box 810 wherein the details of the grouped images are displayed. Corresponding to each imaging process, a series unique identifier is generated and accordingly a new row 820 is created in the tool box 810. Corresponding to each series unique identifier a series number 830 is generated. The images having same series unique identifier is grouped in a single row and the row is displayed with a series number generated corresponding to the series unique identifier. The images having same series number will have same series unique identifiers, indicating that the images are generated in the same tomo process.

One of the technical effects of the system 100 and method 200 is the grouping of images generated in different Tomo acquisitions for the same anatomy in different series.

It should be noted that although the flow charts provided herein show a specific order of method steps, it is understood that the order of these steps may differ from what is depicted. Also, two or more steps may be performed concurrently or with partial concurrence. It is understood that such variations are within the scope of the invention.

Thus various embodiments of the invention provide a method of grouping images generated from a tomosynthesis process. This eliminates the ambiguity among images that have to be reviewed by a doctor or a radiologist. The grouping will help to track the process from the image is generated and this will give the doctor a better view of the anatomy scanned. The invention helps in faster and more accurate diagnosis.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

What is claimed is:

1. A method of grouping series of images generated from a tomosynthesis process comprising the steps of:
(a) generating an identifier during a plurality of imaging stages;
(b) writing the identifier to a DICOM header of a plurality of images; and
(c) displaying images grouped based on the identifier.

2. A method of grouping series of images as claimed in claim 1, wherein the plurality of imaging stages include an image-generating stage including a pre-shot and acquisition stage, and an image-processing stage including a reconstruction and retro-reconstruction stage.

3. A method of grouping series of images as claimed in claim 1, wherein the images include raw images and processed images, the raw images include an image acquired during pre-shot and tomo projections acquired during acquisition, and the processed images include a pre-shot image and tomo slices generated during reconstruction and retro-reconstruction.

4. A method of grouping series of images as claimed in claim 1, wherein the step of generating an identifier comprises generating a series unique identifier during a plurality of imaging stages corresponding to each imaging stage.

5. A method of grouping series of images as claimed in claim 3, wherein the series unique identifier is a DICOM compliant number.

6. A method of grouping series of images as claimed in claim 1, wherein the step of writing the identifier to a DICOM header of the images comprises updating the DICOM header of plurality of images during each imaging stage with corresponding identifier.

7. A method of grouping series of images as claimed in claim 1, wherein the step of displaying further comprises generating a series number corresponding to the series unique identifier.

8. A method of grouping series of images as claimed in claim 7, further comprising displaying the grouped images with the series number, after each imaging stage.

9. A method of grouping series of images as claimed in claim 6, wherein the DICOM header of each image further includes series number, date and time of imaging stages.

10. A tomosynthesis system comprising,
an imager for providing images;
a computer coupled to the imager for grouping the images during a plurality of imaging stages;
wherein the grouping is based on an identifier generated during the plurality of imaging stages.

11. A tomosynthesis system as claimed in claim 10, wherein the plurality of imaging stages comprises an image generating-stage including pre-shot and acquisition stage and an image-processing stage including reconstruction stage and retro-reconstruction stage.

12. A tomosynthesis system as claimed in claim 10, wherein the computer comprises a processor for generating the series unique identifier during each imaging stage, and the series unique identifier includes a DICOM compliant number.

13. A tomosynthesis system as claimed in claim 11, wherein the processor is further configured for writing the identifier to a DICOM header of plurality of images during each imaging stage.

14. A tomosynthesis system as claimed in claim 11, wherein the processor is further configured for generating a series number, corresponding to the series unique identification number for displaying the grouped images.

15. A tomosynthesis system as claimed in claim 10, further comprises a display for displaying grouped images with series number after each imaging stage.

16. A tomosynthesis system as claimed in claim 10, further comprises a user interface for interpreting the identifier from the DICOM header of the images.

17. A tomosynthesis system as claimed in claim 10, wherein the tomosynthesis system includes Mammographic Tomosynthesis system and Radiographiy Tomosynthesis system.

18. A computer program, provided on one or more computer readable media, for grouping series of images obtained from a tomosynthesis process comprising:
a routine for generating an identifier in a plurality of imaging stages;
a routine for writing the identifier to a DICOM header of the images; and
a routine for displaying images grouped based on the identifier.

19. A computer program as claimed in claim 18, wherein the plurality of imaging stages comprise an image-generating stage including a pre-shot and acquisition stage and an image processing stage including reconstruction and retro-reconstruction stage.

20. A computer program as claimed in claim 18, wherein the routine for generating an identifier comprises a routine for generating a DICOM compliant series unique identifier, during each imaging stage.

21. A computer program as claimed in claim 18, wherein the routine for writing the identifier to a DICOM header of the images comprises a routine for updating the DICOM header of plurality of images during plurality of imaging stages with corresponding series unique identifier.

22. A computer program as claimed in claim 18, wherein the routine for displaying the grouped images comprising generating a series number for displaying the images grouped after each imaging stage, based on the series unique identifier.
